(19) United States
(12) Patent Application Publication
(10) Pub. No.: US 2009/0172404 A1
(43) Pub. Date: Jul. 2, 2009

(54) Method and Apparatus for Hybrid Watermarking

(75) Inventors: Won Gyum Kim, Daejeon (KR); Yong-Seok Seo, Daejeon (KR); Seon Hwa Lee, Daejeon (KR); Wonyoung Yoo, Daejeon (KR); Sang Kwang Lee, Daejeon (KR); Sung Hwan Lee, Daejeon (KR); Seungjae Lee, Daejeon (KR); Hye Won Jung, Daejeon (KR); Young-Suk Yoon, Daejeon (KR); Jin Soo Seo, Daejeon (KR); Young Ho Suh, Daejeon (KR); Weon Geun Oh, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/226,915

(22) PCT Filed: Aug. 11, 2006
(86) PCT No.: PCT/KR2006/003145

§ 371 Date: Oct. 31, 2008

(30) Foreign Application Priority Data
May 2, 2006 (KR) 10-2006-0039649

(51) Int. Cl. H04L 9/00; G06K 9/36; G06K 9/46; G06K 9/40

(52) U.S. Cl. 713/176; 382/276; 382/199; 382/260; 382/264

(57) ABSTRACT

A hybrid watermark insertion method includes the steps of dividing the digital image into a low frequency region and a high frequency region using an edge map of the digital image; inserting a watermark into the low frequency region of the image by employing a watermarking method using a human visual system (HVS); and inserting the watermark into the high frequency region of the image by employing a quantization index modulation (QIM) method. A hybrid watermark extraction method includes the steps of estimating a reference value used when inserting a watermark, and searching a maximum value of correlation coefficients in an image of the watermark image while changing the estimated reference value within a designated range, to thereby find out the watermark insertion method. Accordingly, the watermark insertion method can be easily identified, thereby enabling the watermark extraction in a more readily manner.

### TECHNICAL FIELD

The present invention relates to watermarking for inserting/extracting copyright information into/from digital contents to protect the copyright thereof; and, more particularly, to a hybrid watermarking method and apparatus for inserting/extracting copyright information into/from a digital image by applying two different watermarking methods thereto at the same time.

### BACKGROUND ART

As well known, as the distribution of paid digital contents is accelerated recently, there are being made active researches upon how to protect the copyrights of the digital contents. Digital watermarking is a most widely employed technique for protecting copyright, and it involves inserting identification information of a copyright holder into digital contents in an invisible manner; and extracting the copyright information later when using the contents or when an infringement of copyright occurs, to thereby prove the existence of a copyright or an ownership.

One of representative watermarking methods is a method in which an HVS (Human Visual System) is calculated by regarding a watermark as a noise and the calculated HVS is added to a to-be-inserted coefficient of contents in spatial region. Another is a quantization watermarking method in which a bit of 1 or 0 is inserted into a coefficient of contents through quantizing the coefficient into a certain value, which method is called a QIM (Quantization Index Modulation). As for the former method for adding an HVS to a spatial region insertion coefficient, it has advantages in that the HVS can be simply calculated and the insertion operation is simple. With regard to the QIM method, though it has a merit in that a robustness of watermark can be obtained as the quantization step size increases, it also has a defect in that the calculation of a HVS is difficult.

On the other hand, hybrid watermarking is a technical conception for inserting a watermark by combining advantages of more than one watermarking methods.

Disclosed in a paper titled “Analysis and Design of Watermarking Algorithms for Improved Resistance to Compression”, IEEE Transactions on Image Processing, Vol. 13, No. 2, 2004, pages 126 to 144, is a hybrid watermarking method for inserting/extracting watermarks into/from a single image by employing two watermarking techniques. The watermarking techniques are a spread spectrum method and a quantization method. In order to apply two watermarking methods to a single image, it is important to know what watermarking method is used and where this method is applied to the image when inserting a watermark and apply the same method when extracting it. In the above-mentioned paper, a switching table is employed for the purpose. The switching table is designed to be matched with coefficients into which watermarks are to be inserted by a one-to-one correspondence. For example, if a value of the table corresponding to a certain coefficient is 0, the spread spectrum method is carried out to insert a watermark, whereas if a value of the table is 1, the quantization method is carried out to insert the watermark.

Further, proposed in a paper, titled “Multi-level Data Hiding for Digital Image and Video”, SPIE Conference on Multimedia Systems and Applications II, SPIE, Vol. 3845, 1999, pages 10 to 21, is another hybrid watermarking method which employs an odd-even embedding method at a low frequency band of a DCT (Discrete Cosine Transform) domain of an image data, while employing a spread spectra method at a mid and a high band thereof to insert watermarks.

Moreover, also proposed in US Patent Publication No. 20030070075, entitled “Secure hybrid robust watermarking resistance against tampering and copy-attack”, is a method for inserting a robust watermark and a fragile watermark into an image at the same time to obtain both a tamperproofing function and an authentication function. Specifically, a robust watermark is first inserted and its inserted position is determined by a secret key. Then, a fragile watermark is inserted to the rest area where no robust watermark is inserted. The fragile watermark is composed of a hash value of the image into which the robust watermark is inserted. When extracting the watermarks, the fragile watermark is first extracted for the authentication of the image and then the robust watermark is extracted.

However, in the conventional hybrid watermarking methods set forth above, to identify which insertion method is used at which point of an image when extracting a watermark, regions for applying watermarking methods should be predetermined so that discrete watermarking are applied to separate regions under an agreement by or additional information such as a table needs to be employed, which makes digital contents vulnerable to various attacks.

### DISCLOSURE OF INVENTION

### Technical Problem

It is, therefore, the present invention addresses a hybrid watermarking method and apparatus for inserting a watermark into a single image by employing an HVS method and a quantization method at the same time.

In accordance with the present invention, application of one of the two watermarking methods is determined according to an edge map of the image: a watermark insertion is performed by calculating an HVS at a low frequency region of the image, whereas it is performed by a QIM method having a relatively large quantization coefficient at a high frequency region.

Specifically, it is a primary object of the present invention to improve the invisibility of a watermark by way of inserting the watermark into a digital image adaptively by employing the two watermarking methods at the same time.

It is another object of the present invention to increase the robustness of a watermark by way of performing the watermark insertion at a high frequency region of the image by employing the QIM method using a large quantization step size.

It is a further another object of the present invention to provide a method for estimating a reference value of an edge map which is used when inserting a watermark to distinguish a low frequency region and a high frequency region, thus allowing a watermark insertion method to be identified readily at a time of extracting the watermark.

### Technical Solution

In accordance with a first aspect of the present invention, there is provided a hybrid watermark insertion method for inserting a watermark into a digital image, comprising the steps of:

(a) dividing the digital image into a low frequency region and a high frequency region;

(b) inserting the watermark into the low frequency region of the image by employing a watermarking method using a human visual system (HVS); and

(c) inserting the watermark into the high frequency region of the image by employing a quantization index modulation (QIM) method.

In accordance with a second aspect of the present invention, there is provided a hybrid watermark insertion apparatus for inserting a watermark into a digital image, the apparatus comprising:

means for dividing the digital image into a low frequency region and a high frequency region;

means for inserting the watermark into the low frequency region by employing a watermarking method using an HVS; and

means for inserting the watermark into the high frequency region by employing a QIM method.

In accordance with a third aspect of the present invention, there is provided a hybrid watermark extraction method for extracting a watermark from a digital image into which the watermark is inserted by a hybrid watermark insertion, the method comprising the steps of:

(a) dividing the digital image into a low frequency region and a high frequency region;

(b) extracting the watermark from the low frequency region by employing a watermarking method using an HVS; and

(c) extracting the watermark from the high frequency region by employing a QIM method.

In accordance with a fourth aspect of the present invention, there is provided a hybrid watermark extraction apparatus for extracting a watermark from a digital image into which the watermark is inserted by a digital image watermark insertion apparatus employing a hybrid watermark insertion, the apparatus comprising:

means for dividing the digital image into a low frequency region and a high frequency region; and

means for extracting the watermark from the low frequency region by employing a watermarking method using an HVS; and

means for extracting the watermark from the high frequency region by employing a QIM method.

### ADVANTAGEOUS EFFECTS

In accordance with the present invention, by applying two different watermarking methods to a single image to insert a watermark thereto adaptively, the invisibility of the watermark can be improved considerably. Further, since the watermark is inserted into a high frequency region by employing a QIM method using a large quantization coefficient, the robustness of the inserted watermark can be improved.

Moreover, in the watermark insertion process, by estimating a certain reference value of an edge map, which has been used to distinguish a low frequency region and a high frequency region at the time of inserting a watermark, the watermark insertion method can be easily identified, so that the watermark extraction can be carried out more readily.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic block diagram of a hybrid watermark insertion apparatus in accordance with the present invention;

FIG. 2 is a flowchart of a hybrid watermark insertion method in accordance with the present invention;

FIG. 3 sets forth a flowchart of a hybrid watermark extraction method in accordance with the present invention;

FIGS. 4 and 5 illustrate exemplary images to describe a method for obtaining an edge map thereof in the hybrid image watermark insertion method in accordance with the present invention; and

FIGS. 6 and 7 show exemplary images to illustrate a process for generating a unit block of a watermark and repeatedly inserting it into the image in the hybrid watermark insertion method in accordance with the present invention.

### BEST MODE FOR CARRYING OUT THE INVENTION

Hereinafter, preferred embodiments of the present invention will be described in detail with reference to the accompanying drawings. Further, detailed description of known parts or functions will be omitted if there is a concern that their description would render the technical conception of the present invention obscure.

First of all, it will be explained two watermarking methods employed in a hybrid image watermarking method in accordance with the present invention.

One of the two methods is a technique for inserting a watermark by calculating an HVS. To be more specific, an HVS is calculated by way of regarding a watermark as a noise of an image, and the watermark is inserted into a spatial region of the image according to the HVS so calculated. The equation for the watermark insertion is as follows:

x′=x+α*β*w MathFigure 1

wherein x is an insertion coefficient; x′ refers to a signal into which a watermark is inserted; w represents a watermark to be inserted; α is a global insertion strength of a watermark for the whole region of the image; and β is a local insertion strength of the watermark.

In general, β is calculated by using an HVS function reflecting a local characteristic of a coefficient.

As for the watermark insertion method using the HVS, extraction of the watermark is performed in general by using a noise removing filter such as a low pass filter or a Wiener filter. A noise is extracted from the image into which a watermark is inserted by using the noise removing filter. Here, it is assumed that a watermark signal is contained in the extracted noise. A final determination upon the existence of the watermark is made by means of a correlation function between the inserted watermark signal and the extracted noise signal.

The other watermarking method employed in the present invention is a QIM method on quantization. The QIM method is a technique for inserting a 1-bit message to a coefficient, into which a watermark is to be inserted, as a watermark. In this method, a quantization coefficient is used but no key is utilized. A scalar, uniform quantizer Q(s) having a quantization coefficient Δ is defined as follows:

$$Q ( s ) = Δ ⌊ \frac{s}{Δ} ⌋ \qquad MathFigure 2$$

By using the quantizer, a quantization function can be defined as follows:

Qᵢ(s)=Q(s−dᵢ)+dᵢ, i=0,1 MathFigure 3

The quantization function is defined as follows for the insertion of a watermark:

$$x = \{ \begin{matrix}{Q}_{0} ( s ) & \text{:} m = 0 \\ {Q}_{1} ( s ) & \text{:} m = 1\end{matrix} \qquad MathFigure 4$$

wherein s is a coefficient into which a watermark is to be inserted; m is bit information to-be-inserted; and x is a coefficient into which the watermark is inserted.

In the QIM method, a watermark is extracted as follows.

A signal y obtained by adding a noise w to a signal x into which a watermark is inserted is defined by the following equation:

y=x+w MathFigure 5

Then, the inserted watermark message is extracted from y by using the following equation:

$$\hat{m} = {arg min}_{m ∈ \{ 0 , 1 \}} ‖ y - {Q}_{i} ( y ) ‖ \qquad MathFigure 6$$

A QIM decoder is a minimum-distance decoder, and if a condition

|w|=<Δ/4

is satisfied, it implies that an extracted message completely coincides with an inserted message. If the value A is great, a permissible tolerance increases, resulting in improvement of the robustness but deterioration of invisibility. Further, the value A serves as a security key when inserting a watermark.

The present invention provides a hybrid watermarking method of the watermark insertion and extraction in which the above-described two separate watermarking methods are applied to a single image.

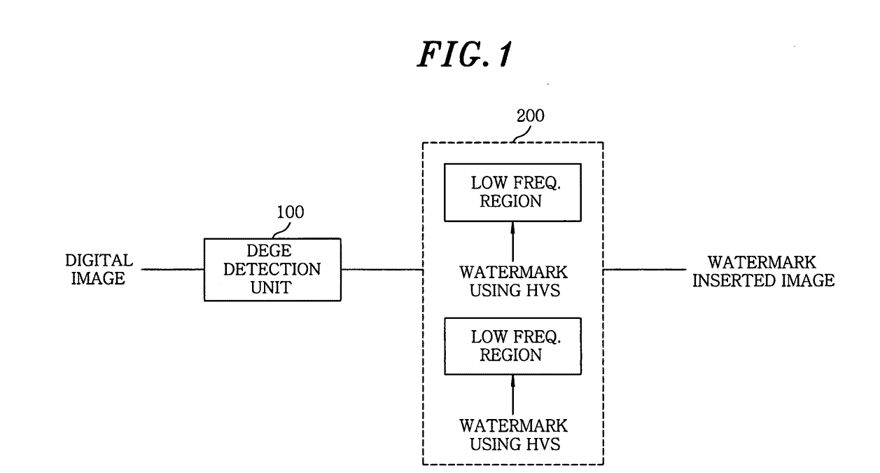

Referring now to FIG. 1, there is shown a schematic block diagram of a hybrid watermark insertion apparatus in accordance with the present invention.

As shown in FIG. 1, the hybrid image watermark insertion apparatus includes an edge map detection unit 100 and a hybrid watermarking unit 200. A digital image into which a watermark is to be inserted is provided to the edge map detection unit 100. The edge map detection unit 100 detects an edge map from the digital image using an edge detection mask such as a Prewitt and a Sobel. Then, the edge map detection unit 100 compares the detected edge map with a preset reference value to divide the image into a low frequency region and a high frequency region. The hybrid watermarking unit 200 serves to insert a watermark into the low frequency region by employing a watermarking method using an HVS and the watermark into the high frequency region by employing a QIM method, to thereby produce a digital image having the watermark embedded therein.

Below, there will be provided a further detailed description on a process for inserting the watermark into the digital image.

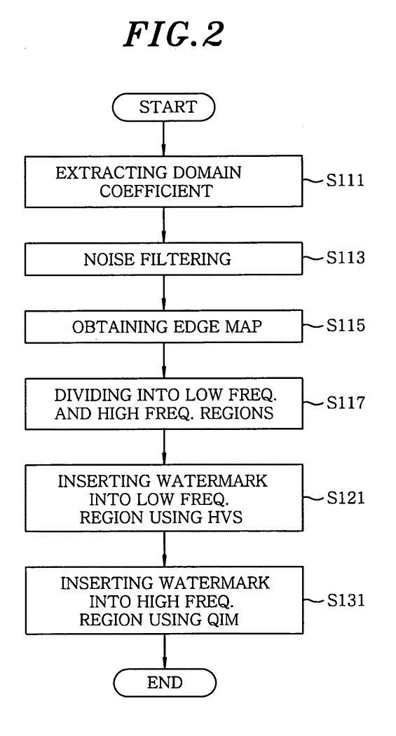

FIG. 2 is a flowchart of a hybrid image watermark insertion method in accordance with the present invention.

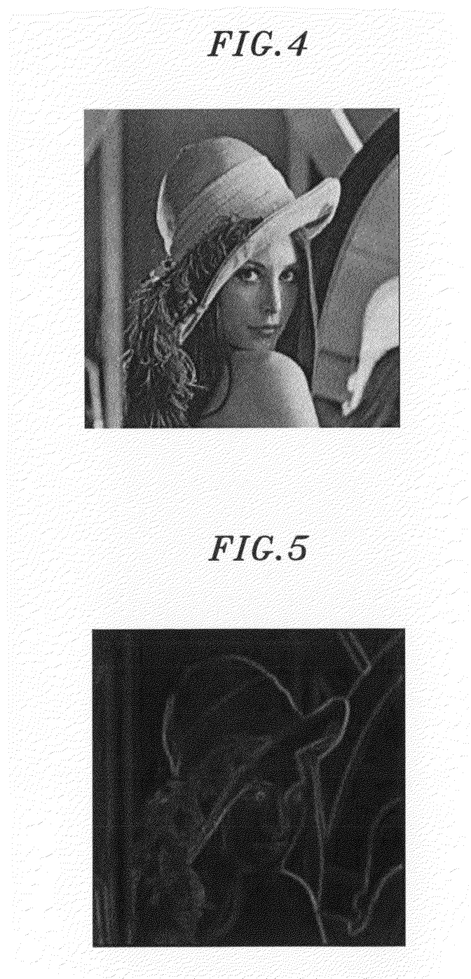

First, as for a digital image, a coefficient of a designated area within the digital image into which a watermark is to be inserted is extracted, i.e., a brightness or a coefficient of a spatial region of the image of blue channel is extracted (S111) and then is subjected to a noise filter such as a low pass filter or a Wiener filter (S113). Then, from the digital image, e.g., an original image as shown in FIG. 4, an edge map as shown in FIG. 5 is obtained by using an edge detection mask such as a Prewitt and a Sobel (S115).

Thereafter, the image is divided into two regions by using the edge map, i.e., a high frequency region and a low frequency region (S117) according to the following equation and different watermarking methods are respectively applied to them.

$$x = \{ \begin{matrix} x + α ⋆ β ⋆ w & if E ( x ) < T \\ {Q}_{Δ} ( x ) & Otherwise\end{matrix} \qquad MathFigure 7$$

Here, T represents a reference value for dividing the image into the high frequency region and the low frequency region, and it may be set to be a mean value of the edge map or an arbitrary constant. On a flat region having an edge map of lower value, a watermark insertion method using an HVS is employed to reduce insertion distortion (S121), while a QIM method using a high value A is employed on a high frequency region having an edge map of higher value to insert a watermark thereto robustly (S131).

If the regions into which a watermark is inserted are determined depending on the edge map, the watermark is made into a unit block, and the unit block is then repetitively inserted into the regions. The size of the unit block is smaller than that of the digital image, and it can be maximally set to be ¼ of the size of the digital image and further decreases accordingly as the watermark insertion is repeated.

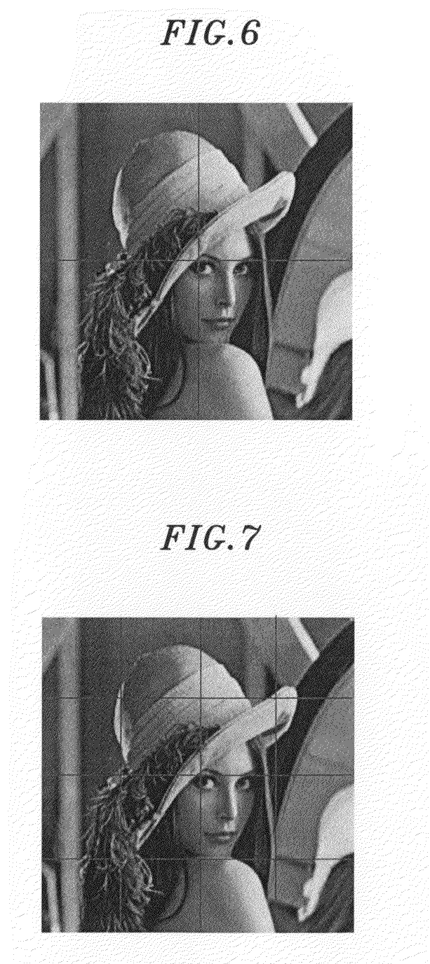

FIGS. 6 and 7 illustrate exemplary images to which the repetitive insertion of the unit block is performed four and sixteen times, respectively. The reason why the watermark is repetitively inserted into the entire spatial region of the image on a block basis is as follows: if the auto-correlation of the image is calculated by using an autocorrelation function after completing the repetitive insertion of the watermark, a high energy is generated on a unit block basis, and these energies can be utilized when extracting the watermark.

When performing the hybrid watermark insertion method as described above, the nose filter, the edge detection mask and the like may be identified as an edge detection unit for distinguishing a low frequency region and a high frequency region along with a microprocessor programmed to execute a sequence for detecting an edge map. Similarly, the microprocessor and the like, which is programmed to execute a sequence for inserting a watermark into a digital image, may be referred to as a hybrid watermarking unit.

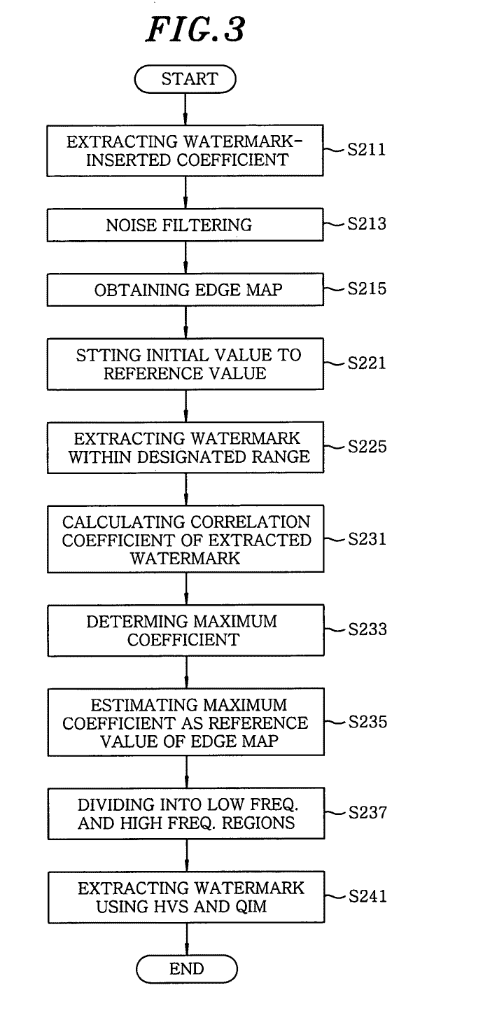

Then, a hybrid watermark extraction method in accordance with the present invention will be described with reference to FIG. 3.

Referring to FIG. 3, the extraction method involves the steps of obtaining an edge map of a digital image in which a watermark is inserted (S211 to S215); setting a mean value of the edge map as a reference value which has been used in the watermark insertion process (S221); extracting a watermark by way of a QIM method while changing the reference value within a designated range (S225); searching a maximum auto-correlation coefficient to determine the maximum value as the reference value (S231 to S235); dividing the edge map into a low frequency region and a high frequency region (S237); and then extracting a watermark from the low frequency region by employing a watermarking method using an HVS, while extracting a watermark from the high frequency region by employing a QIM method (S241).

Below, the process for extracting a watermark from a digital image by the watermark extraction method as defined above will be explained in further detail.

The technical key of watermark extraction is to estimate a reference value T of an edge map which has been used when inserting a watermark. For the purpose, a coefficient into which a watermark has been inserted is extracted from an image into which the watermark has been inserted (S211) and then it is subjected to a noise filtering using a low pass filter and a Wiener filter (S213). Thereafter, an edge map is obtained by using an edge detection mask such as a Prewitt and a Sobel (S215). In this regard, if a distortion of the image has occurred, the value of the edge map would be different from that at the time of inserting the watermark.

Then, the reference value T is estimated as follows.

First, the mean value of the edge map is set as the reference value T (S221).

Thereafter, a watermark is extracted while changing the reference value within a designated range by applying Eq. 6 reversely (S225).

The designated range is set with respect to the reference value T as represented by the following equation in order to achieve an optimum reference value.

(Tₛₜₐᵣₜ=T−k)≦T≦(T_{end}=T+k) MathFigure 8

Here, k is an arbitrary constant. For example, if the mean value of the edge map is 25 and k is 20, T ranges from 5 to 45.

Subsequently, an auto-correlation coefficient is calculated by applying an autocorrelation function to the watermark extracted in the step S225 (S231). Then, a mask window having a size of, e.g., 6464 pixels is covered on the image and a maximum value of the auto-correlation coefficients within the window is extracted (S233). Here, the size of the mask window may be modified as required.

By repeatedly performing the steps 225 to S233 for the whole range of the reference value, the reference value T which makes the auto-correlation coefficient have its maximum value is searched and the maximum value of the coefficient is ultimately estimated as the reference value T used for the watermark insertion (S235). That is, by performing extractions for the whole range of the reference value T, one of the reference values Ts capable of optimizing the extracted values is presumed as a reference value T.

Finally, if the reference value T of the edge map is estimated, the reference value T is applied to Eq. 7 and the digital image is divided into a low frequency region and a high frequency region using the edge map (S237). Then, a watermark extraction is executed in the low frequency region by a watermarking method using an HVS, whereas a watermark extraction is performed in the high frequency region by a QIM method (S241).

When performing the hybrid watermark extraction method as described above, the nose filter, the edge detection mask and the like may be identified as frequency dividing scheme for distinguishing a low frequency region and a high frequency region along with a microprocessor programmed to execute the inventive watermark extraction method. Further, the microprocessor, and the like may be referred to as a watermark extraction scheme, which is programmed to execute the inventive watermark extraction method.

As described above, the hybrid image watermarking method in accordance with the present invention can be used to insert/extract additional information including copyright information into/from a 2D computer graphic image or to insert/extract copyright information into/from a computer graphic image to verify the ownership of a digital cinema or to chase an illegal distributor thereof.

While the invention has been shown and described with respect to the preferred embodiments, it will be understood by those skilled in the art that various changes and modifications may be made without departing from the spirit and scope of the invention as defined in the following claims.

1. A hybrid watermark insertion method for inserting a watermark into a digital image, comprising the steps of:
(a) dividing the digital image into a low frequency region and a high frequency region;
(b) inserting the watermark into the low frequency region of the image by employing a watermarking method using a human visual system (HVS); and
(c) inserting the watermark into the high frequency region of the image by employing a quantization index modulation (QIM) method.

2. The method of claim 1, wherein the step (a) includes:
(a1) obtaining an edge map of the digital image; and
(a2) comparing the edge map with a preset reference value to divide the digital image into the low frequency region and the high frequency region.

3. The method of claim 2, wherein the step (a1) includes:
extracting, from the digital image, a coefficient of a frequency domain into which the watermark is to be inserted;
performing a noise filtering on the extracted frequency coefficient; and
detecting an edge map of the image by using an edge detection mask, to thereby obtaining the edge map.

4. The method of claim 3, wherein the noise filtering is performed by using a low pass filter or a Wiener filter.

5. The method of claim 3, wherein the mask is a Prewitt or a Sobel.

6. The method of claim 2, wherein the reference value in the step (a2) is a mean value of the edge map or an arbitrary constant.

7. The method of claim 1, wherein each of the steps (b) and (c) includes:
making the watermark into a unit block, the unit block being smaller than the digital image; and
repeatedly inserting the unit block into the entire spatial region of the digital image.

8. The method of claim 7, wherein the size of the unit block is set to be ¼ of a size of the digital image and decreases accordingly as the watermark insertion proceeds.

9. A hybrid watermark insertion apparatus for inserting a watermark into a digital image, the apparatus comprising:
means for dividing the digital image into a low frequency region and a high frequency region;
means for inserting the watermark into the low frequency region by employing a watermarking method using an HVS; and
means for inserting the watermark into the high frequency region by employing a QIM method.

10. A hybrid watermark extraction method for extracting a watermark from a digital image into which the watermark is inserted by a hybrid watermark insertion, the method comprising the steps of:
(a) dividing the digital image into a low frequency region and a high frequency region;
(b) extracting the watermark from the low frequency region by employing a watermarking method using an HVS; and
(c) extracting the watermark from the high frequency region by employing a QIM method.

11. The method of claim 10, wherein the hybrid watermarking method involves the steps of generating an edge map of the digital image; dividing the edge map into a low frequency region and a high frequency region by comparing the edge map with a preset reference value; inserting the watermark into the low frequency region by the watermarking method using the HVS; and inserting the watermark into the high frequency region by the QIM method, and wherein the step (a) includes:
(a1) obtaining an edge map of the digital image into which the watermark has been inserted;
(a2) estimating the reference value from the edge map obtained in the step (a1); and
(a3) dividing the digital image into the low frequency region and the high frequency region by comparing the edge map obtained in the step (a1) with the reference value.

12. The method of claim 11, wherein the step (a1) includes:
extracting, from the digital image, a coefficient of a domain into which the watermark is to be inserted;
performing a noise filtering on the coefficient; and
detecting an edge of the image by using an edge detection mask to thereby obtain the edge map of the image.

13. The method of claim 12, wherein the noise filtering is performed by using a low pass filter or a Wiener filter.

14. The method of claim 12, wherein the mask is a Prewitt or a Sobel.

15. The method of claim 11, wherein the step (a2) includes:
(a21) setting a mean value of the edge map obtained in the steps (a1) as an initial value of the reference value;
(a22) extracting the watermark from the digital image by way of the QIM method while changing the initial value within a designated range;
(a23) applying an auto-correlation function to the watermark extracted in the step (a22) to thereby obtaining an auto-correlation coefficient;
(a24) searching a maximum value of coefficients within the digital image using a mask window of a predetermined size; and
(a25) presuming a reference value which making the coefficient have the maximum value obtained in the step (a24) as the reference values.

16. The method of claim 15, wherein the designated range in the step (a22) is determined by an equation as follows:
(Tₛₜₐᵣₜ=T−k)≦T≦(T_{end}=T+k)
wherein T represents the reference value and k is an arbitrary constant.

17. A hybrid watermark extraction apparatus for extracting a watermark from a digital image into which the watermark is inserted by a digital image watermark insertion apparatus employing a hybrid watermark insertion, the apparatus comprising:
means for dividing the digital image into a low frequency region and a high frequency region; and
means for extracting the watermark from the low frequency region by employing a watermarking method using an HVS; and
means for extracting the watermark from the high frequency region by employing a QIM method.

18. A method for inserting or extracting additional information including copyright information into or from a 2D computer graphic image by employing the methods disclosed in the foregoing claims.

19. The method of claim 18, wherein the copyright information is inserted or extracted to verify an ownership of a digital cinema and to chase an illegal distributor thereof.
